(19) United States
(12) Patent Application Publication
(10) Pub. No.: US 2012/0054523 A1
(43) Pub. Date: Mar. 1, 2012

(54) ELECTRONIC DEVICE AND DATA TRANSMISSION METHOD OF THE SAME

(75) Inventors: Chi-Leng Wang, Taoyuan City (TW); Ssu-Po Chin, Taoyuan City (TW)

(73) Assignee: HTC CORPORATION, Taoyuan City (TW)

(21) Appl. No.: 13/149,062

(22) Filed: May 31, 2011

Related U.S. Application Data
(60) Provisional application No. 61/377,794, filed on Aug. 27, 2010.

(51) Int. Cl. G06F 1/32

(52) U.S. Cl. 713/323

(57) ABSTRACT

A data transmission method adapted in an electronic device is provided. The data transmission method comprises the steps as follows. The electronic device is operated in a sleep period, wherein at least one first data-transmitting packet is stored in a data-transmitting register. When the sleep period is finished, the electronic device is operated in a wake-up period, wherein during the wake-up period, the first data-transmitting packet is sent to an external network. When the wake-up period is finished, the electronic device is operated in the sleep period again. An electronic device is disclosed herein as well.

### RELATED APPLICATIONS

This application claims priority to U.S. provisional Application Ser. No. 61/377,794, filed Aug. 27, 2010, which is herein incorporated by reference.

### BACKGROUND

1. Technical Field

The present disclosure relates to an electronic device that is able to transmit data. More particularly, the present disclosure relates to an electronic device and a data transmission method of the same.

2. Description of Related Art

The electronic devices such as cell phones and computers bring convenience to our life. The communication and the information exchange becomes fast and easy. As the trend towards smaller size continues, the design of a more efficient and power-saving electronic devices is necessary.

In the current design, the electronic device transmits the packet to the external network immediately after the packet is generated. When the electronic device is connected to the websites such as Facebook or Twitter, the data access may be performed frequently to access these websites. However, these data accesses are not urgent to the system of the electronic device. If the system transmits the packet every time the data access is generated, the electronic device will consume lots of power. Hence, the battery is not able to support the electronic device for a long time.

Accordingly, what is needed is an electronic device having a mechanism to dynamically adjust its operation mode. The present disclosure addresses such a need.

### SUMMARY

An aspect of the present disclosure is to provide a data transmission method adapted in an electronic device. The data transmission method comprises the steps as follows. The electronic device is operated in a sleep period, wherein at least one first data-transmitting packet is stored in a data-transmitting register during the sleep period. The electronic device is operated in a wake-up period when the sleep period is finished, wherein during the wake-up period, the first data-transmitting packet stored in the data-transmitting register is transmitted to an external network. The electronic device is operated in the sleep period when the wake-up period is finished

According to an embodiment of the present disclosure, wherein the step of operating the electronic device in the sleep period further comprises operating the electronic device in the wake-up period when a data-receiving packet is received to further transmit the first data-transmitting packet stored in the data-transmitting register to the external network; and operating the electronic device in the sleep period when the wake-up period is finished.

According to another embodiment of the present disclosure, wherein the step of operating the electronic device in the sleep period further comprises operating the electronic device in the sleep period when a display panel of the electronic device is in operation.

According to yet another embodiment of the present disclosure, wherein the step of operating the electronic device in the sleep period further comprises transmitting a second data-transmitting packet generated by a specific application program to the external network.

Another aspect of the present disclosure is to provide an electronic device comprising a processing module, a data-transmitting register and a data-transmission control module. The processing module operates the electronic device in a sleep period and a wake-up period in turn and to generate at least one first data-transmitting packet. The data-transmission control module stores the first data-transmitting packet in the data-transmitting register during the sleep period and transmits the first data-transmitting packet stored in the data-transmitting register to an external network during the subsequent wake-up period.

According to an embodiment of the present disclosure, wherein when a data-receiving packet is received during the sleep period, the processing module operates the electronic device in the wake-up period and operates the electronic device in the sleep period when the wake-up period is finished. When the data-receiving packet is received during the sleep period, the processing module transmits the first data-transmitting packet stored in the data-transmitting register to the external network.

According to another embodiment of the present disclosure, the electronic device further comprises a display panel, wherein when the display panel of the electronic device is in operation, the processing module operates the electronic device in the sleep period.

According to yet another embodiment of the present disclosure, wherein when the electronic device is operated in the sleep period, the data-transmission control module transmits a second data-transmitting packet generated by a specific application program to the external network. The specific application program is an instant communication program.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of the electronic device of an embodiment of the present disclosure;

FIG. 2 is a flow chart of the data transmission method of an embodiment of the present disclosure;

FIG. 3 is a more detailed flow chart of the wake-up period in step 204 of FIG. 2; and

FIG. 4 is a timing diagram of the data transmission of the electronic device in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

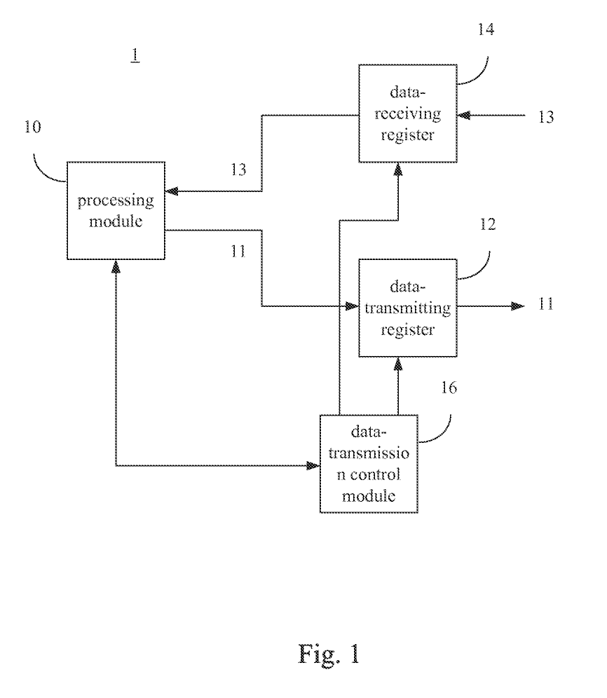

Please refer to FIG. 1. FIG. 1 is a block diagram of the electronic device 1 of an embodiment of the present disclosure. The electronic device 1 comprises a processing module 10, a data-transmitting register 12, a data-receiving register 14 and a data-transmission control module 16.

In an embodiment, the processing module 10 is a central processing unit

(CPU) to perform the computation of the data from various application programs. The processing module 10 can further transmit data to an external network or receive data from the external network. The data-transmitting register 12 and the data-receiving register 14 can be integrated in a network module (not shown) of the electronic device 1 in an embodiment.

When the processing module 10 performs the data transmission, the data-transmitting packet 11 generated by the processing module 10 is transmitted to the external network through the data-transmitting register 12. On the other hand, the processing module 10 can receive the data-receiving packet 13 from the external network through the data-receiving register 14. The data-transmission control module 16 further controls the transmission and reception of the data according to the status of the data-transmitting register 12 and the data-receiving register 14 or the command from the processing module 10. In an embodiment, the processing module 10 and the data-transmission control module 16 are different modules that together control the data transmission according to each other's information. In other embodiments, the processing module 10 and the data-transmission control module 16 can be integrated in the same module.

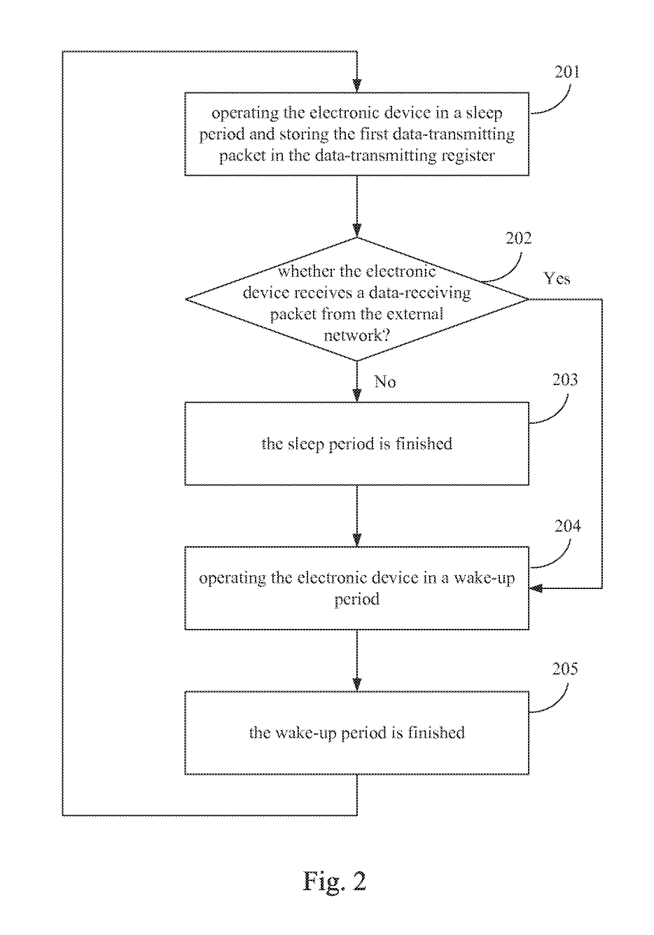

Please refer to FIG. 2. FIG. 2 is a flow chart of the data transmission method of an embodiment of the present disclosure. The data transmission method can be adapted in the electronic device 1 depicted in FIG. 1. The data transmission method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, the processing module 10 operates the electronic device 1 in a sleep period. In an embodiment, the processing module operates the electronic device 1 in the sleep period when the display panel (not shown) of the electronic device 1 is not in operation to save the power. In another embodiment, the processing module 10 can operate the electronic device 1 in the sleep period when the display panel is in operation as well.

During the sleep period, the data-transmission control module 16 stores the first data-transmitting packet 11 generated by the processing module 10 in the data-transmitting register 12. Consequently, the first data-transmitting packet 11 generated by the processing module 10 is stored in the data-transmitting register 12 instead of being transmitted to the external network.

In step 202, the processing module 10 determines whether the electronic device 1 receives a data-receiving packet 13 from the external network. More specifically, the processing module 10 determines whether the data-receiving register 14 receives the data-receiving packet 13 from the external network. If the data-receiving register 14 does not receive the data-receiving packet 13 from the external network, the sleep period will be finished after a specific time period in step 203. The processing module 10 further operates the electronic device 1 in the wake-up period subsequent to the end of the sleep period.

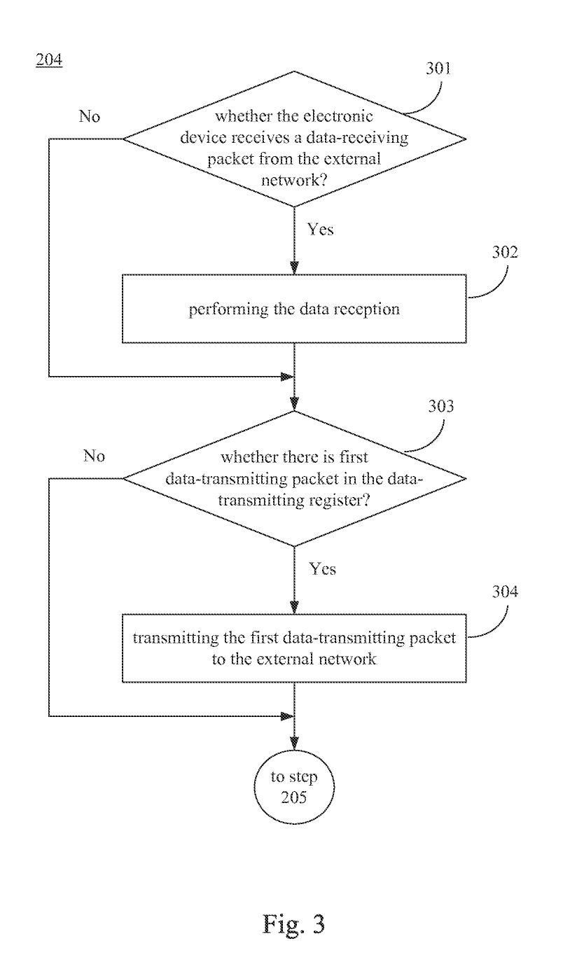

Please refer to FIG. 3. FIG. 3 is a more detailed flow chart of the wake-up period in step 204.

In step 301, the processing module 10 determines whether the electronic device 1 receives the data-receiving packet 13 from the external network. If the data-receiving packet 13 is received, the data-transmission control module 16 further controls the data-receiving register 14 receives the data in step 302 to further make the processing module 10 receives the data from the data-receiving register 14. If step 302 is finished or if the processing module 10 determines that there is no received data-receiving packet 13, the processing module 10 further determines whether there is first data-transmitting packet 11 in the data-transmitting register 12 in step 303. If there is at least one first data-transmitting packet 11, the data-transmission control module 16 controls the data-transmitting register 12 to transmit the data-transmitting packet 11 accumulated in the data-transmitting register 12 to the external network in step 304.

If step 304 is finished or the processing module 10 determines that there is no first data-transmitting packet 11 stored in the data-transmitting register 12 in step 303, the flow goes back to FIG. 2. The wake-up period is finished in step 205. The processing module 10 operates the electronic device 1 in the sleep period, i.e. step 201, again.

If the processing module 10 determines that the electronic device 1 receives the data-receiving packet 13 from the external network in step 202, the processing module 10 operates the electronic device 1 in the wake-up period in step 204 directly. However, if the processing module 10 already determines that the electronic device 1 receives the data-receiving packet 13 in step 202, step 301 in the flow depicted in FIG. 3 can be neglected to perform step 302 directly.

It's noticed that the order of the data transmission and data reception in the flow depicted in FIG. 3 can be adjusted according to the practical situation. Steps 303 and 304 related to the data transmission can be performed first while steps 301 and 302 related to the data reception are performed later. In another embodiment, part of the steps depicted in FIG. 3 can be performed simultaneously. In other words, the data transmission process and the data reception process can be performed simultaneously during the wake-up period without being limited by the order depicted in FIG. 3.

In an embodiment, a time-counting mechanism can be adapted to determine whether the sleep period or the wake-up period is finished. For example, the duration of the sleep period can be predetermined to be ten minutes while the duration of the wake-up period can be predetermined to be one minute. The processing module 10 determines whether the sleep period or the wake-up period is finished in accordance with the predetermined duration described above. In other embodiments, the duration of the sleep period and the wake-up period can be varied or other mechanism can be adapted to determine whether the sleep period or the wake-up period is finished.

Consequently, the power-saving mechanism provided by operating the electronic device 1 in the sleep period and the wake-up period in turn can prevent the electronic device 1 from keeping accessing the websites through the external network when part of the network programs are executed. Hence, the power consumed by the continuous data transmission can be avoided. The electronic device 1 makes the packet supposed to be transmitted directly stored in the data-transmitting register 12 during the sleep period. Accordingly, the accumulated packets are not transmitted until the wake-up period. If there are packets received from the external network during the sleep period, the electronic devices can switch to wake-up period immediately to receive the packets and transmit the packets accumulated in the data-transmitting register 12 during the wake-up period. The high efficiency of the data transmission can be accomplished.

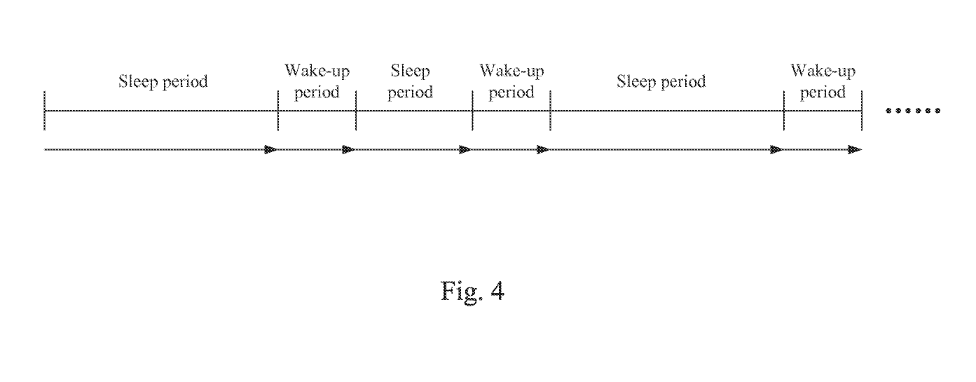

Please refer to FIG. 4. FIG. 4 is a timing diagram of the data transmission of the electronic device in an embodiment of the present disclosure. At first, the electronic device is operated in the sleep period. Subsequent to the end of the sleep period, the electronic device is operated in the wake-up period having a shorter duration than the sleep period. The electronic device is operated in the sleep period again after the wake-up period is finished. However, a data-receiving packet is received during the second sleep period. The electronic device immediately seizes the sleep period and switches to the wake-up period to perform the data transmission. After the wake-up period is finished, the electronic device is kept operating in the subsequent sleep period and the wake-up period again.

In an embodiment, the processing module 10 can further determine whether a second data-transmitting packet (not shown) is generated by specific application programs during the sleep period. The specific application programs may comprise instant communication program. The second data-transmitting packet generated by such a kind of programs needs to be transmitted immediately. Hence, when the second data-transmitting packet is generated by the specific application programs, the data-transmission control module 16 can make the second data-transmitting packet transmitted to the external network directly.

The electronic device in the present disclosure can provide the power-saving mechanism by being operated in the sleep period and the wake-up period in turn to avoid the power consumed by the continuous data transmission.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A data transmission method adapted in an electronic device comprising the steps of:
operating the electronic device in a sleep period, wherein at least one first data-transmitting packet is stored in a data-transmitting register during the sleep period;
operating the electronic device in a wake-up period when the sleep period is finished, wherein during the wake-up period, the first data-transmitting packet stored in the data-transmitting register is transmitted to an external network; and
operating the electronic device in the sleep period when the wake-up period is finished.

2. The data transmission method of claim 1, wherein the step of operating the electronic device in the sleep period further comprises operating the electronic device in the wake-up period when a data-receiving packet is received to further transmit the first data-transmitting packet stored in the data-transmitting register to the external network; and operating the electronic device in the sleep period when the wake-up period is finished.

3. The data transmission method of claim 1, wherein the step of operating the electronic device in the sleep period further comprises:
operating the electronic device in the sleep period when a display panel of the electronic device is in operation.

4. The data transmission method of claim 1, wherein the step of operating the electronic device in the sleep period further comprises transmitting a second data-transmitting packet generated by a specific application program to the external network.

5. An electronic device comprising:
a processing module to operate the electronic device in a sleep period and a wake-up period in turn and to generate at least one first data-transmitting packet;
a data-transmitting register; and
a data-transmission control module to store the first data-transmitting packet in the data-transmitting register during the sleep period and to transmit the first data-transmitting packet stored in the data-transmitting register to an external network during the subsequent wake-up period.

6. The electronic device of claim 5, wherein when a data-receiving packet is received during the sleep period, the processing module operates the electronic device in the wake-up period and operates the electronic device in the sleep period when the wake-up period is finished.

7. The electronic device of claim 6, wherein when the data-receiving packet is received during the sleep period, the processing module transmits the first data-transmitting packet stored in the data-transmitting register to the external network.

8. The electronic device of claim 5, further comprising a display panel, wherein when the display panel of the electronic device is in operation, the processing module operates the electronic device in the sleep period.

9. The electronic device of claim 5, wherein when the electronic device is operated in the sleep period, the data-transmission control module transmits a second data-transmitting packet generated by a specific application program to the external network.

10. The electronic device of claim 9, wherein the specific application program is an instant communication program.
